(19) United States
(12) Patent Application Publication
(10) Pub. No.: US 2019/0105743 A1
(43) Pub. Date: Apr. 11, 2019

(54) INTEGRATED AUTOMATIC BALANCING SYSTEM FOR AERIAL TUBE BUNDLE EXTRACTORS

(71) Applicant: IDROJET S.R.L., Camporotondo Etneo (IT)

(72) Inventors: Danilo LA FERLA, Santa Maria di Licodia (IT); Francesco VIGLIANTI, Sant'Agata Li Battiati (IT)

(21) Appl. No.: 16/087,957

(22) PCT Filed: Mar. 25, 2016
(86) PCT No.: PCT/IT2016/000079

§ 371 Date: Sep. 24, 2018

(51) Int. Cl. B23P 19/02; B66C 1/10; B66C 13/04

(52) U.S. Cl. CPC B23P 19/024; B66C 13/04; B66C 1/10

(57) ABSTRACT

The present invention relates to an integrated automatic balancing system for aerial tube bundle extractors.

### FIELD OF APPLICATION

The present invention relates to an automatic balancing system for aerial tube bundle extractors.

### BACKGROUND

The system which will be described hereinafter is intended to be integrated in machines for extracting tube bundles, working in industrial environment, in particular in the field of handling circular shaped metal loads, with variable length and weight, however always in the order of tens or hundreds of tons.

The tube bundle extractors are machines working in suspension, several meters from the ground, supported by a crane or other similar machine, at only one suspension point. It is thus evident that during the procedure for transferring the tube bundle onto the apparatus, the balancing of the weights is subjected to important changes and consequently the horizontal attitude of the apparatus itself is subjected to important changes.

Such changes in the horizontal attitudes are particularly dangerous as they can determine an unbalance of the bundle and the fall thereof onto the ground, with easily imaginable consequences.

Up to now, the machine balancing during the load transfer is controlled manually by an operator who, by means of a remote control, actuates actuators which move the suspension point so as to restore the correct horizontal attitude.

However, such correction mode is particularly disadvantageous. First of all as it requires the intervention of a human operator and then it assumes a very high level of attention and competence. Furthermore, the need for a manual intervention involves an error margin and then an even very high accident risk.

Furthermore, the manual action has to be performed repeatedly during the load transfer. In this sense, whenever an operator has to control the attitude, and in case to correct it by acting onto the actuators, he/she necessarily has to interrupt the loading procedure, with consequent time loss.

### SUMMARY OF THE INVENTION

The object of the present invention is then to overcome the above-illustrated problems, and this is obtained by means of an integrated automatic balancing system as defined in claim 1.

An additional subject of the present application is an aerial tube bundle extractor integrating an automatic balancing system, as defined in claim 5.

Additional features of the present invention are defined in the corresponding depending claims.

The present invention, by overcoming the problems of known art, involves several and evident advantages.

In particular, the present invention allows performing automatically, that is without human intervention, the correction of the horizontal attitude of the extractor.

Furthermore, such correction takes place continuously during the transfer, and above all without the need for interrupting the loading (or discharging) procedure. Consequently, the present invention allows shortening the load transfer time and then the effectiveness of the whole plant.

Other advantages, together with the features and use modes of the present invention will be evident from the following detailed description of preferred embodiments thereof, shown by way of example and not for limitative purpose. In the following description the enclosed figures will be referred to wherein:

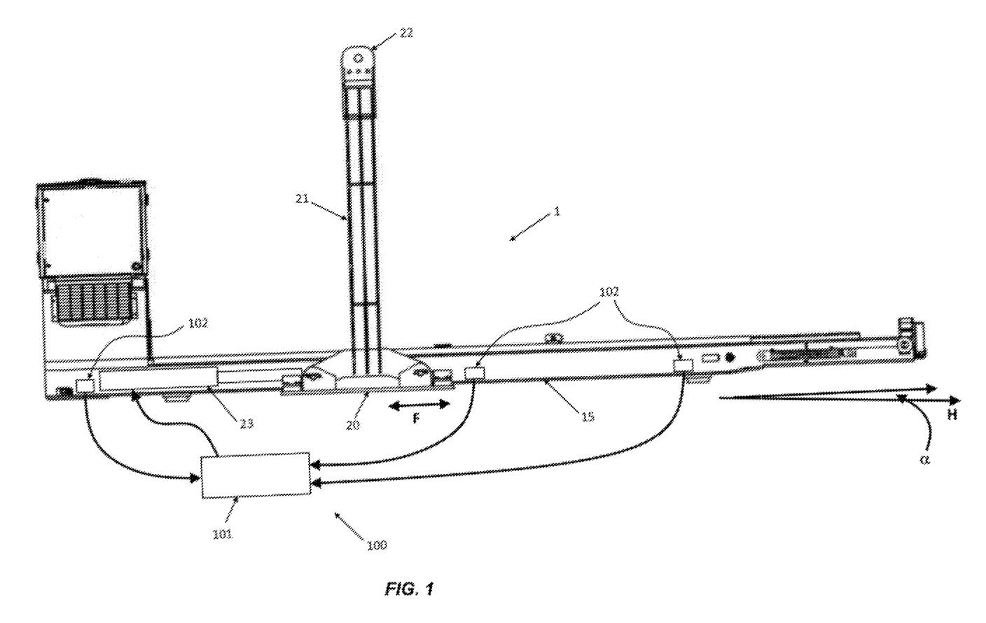

FIG. 1 shows schematically a system according to the present invention; and

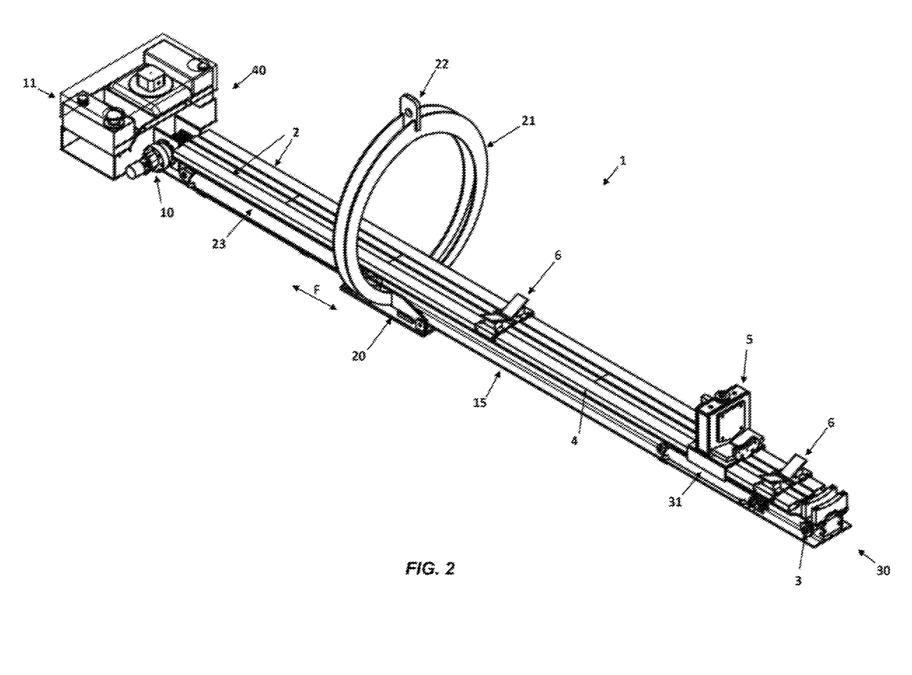

FIG. 2 represents an overall view of an extractor for tube bundles according to the present invention.

### DETAILED DESCRIPTION OF EMBODIMENTS OF THE INVENTION

By referring to the enclosed FIG. 2, an aerial tube bundle extractor 1 is shown.

Generally, such apparatus 1 first of all comprises a bearing slide 15 and means 3, 4, 5, 6, 10 for hooking and dragging a load on such slide 15.

The whole apparatus is designed to work in suspension, thus suspended on a lifting system (crane or other). To this purpose, the machine 1 comprises means for the aerial suspension 20, 21, 22. For positioning the machine at the wished height usually a crane is used.

Advantageously, said means for the aerial suspension 20, 21, 22 comprises a resting plate 20 for the bearing slide 15. The resting plate 20 is slidably mounted below the bearing slide 15, which is then supported by the plate 20, which will have a suitable surface, sized according to the sizes of the machine, to be determined according to the type of loads therefor the machine is intended.

A supporting structure 21, integral to the resting plate 20, can be provided. For example, as shown by way of example in figure, such structure can have the shape of a ring 21 with sizes so as to allow, inside thereof, the passage of the object to be handled.

The supporting structure 21, in turn, comprises a suspension element 22, for the connection to the lifting system, for example a suspension ring 22.

FIG. 1 shows schematically an automatic balancing system 100 according to the the present invention, to be integrated (or which can be integrated) in an aerial extractor for tube bundles 1 of the herein described type.

In particular, such integrated balancing system 100 first of all comprises a device for the longitudinal motion of the means for the aerial suspension (20, 21, 22) along the bearing slide 15 so as to balance continuously possible oscillations of the machine due to weight shifting during the load-handling procedures.

One or more tilting sensors 102 are also provided, arranged so as to be able to detect tilting variations a of the slide 15 with respect to a reference, for example with respect to a reference line H, for example the horizon.

A control unit 101, preferably a microprocessor, is programmed to acquire continuously data measured by said tilting sensors 102, to process them to verify if they exceed a predefined tilting threshold, and if such threshold is exceeded, to actuate instantaneously the device for the longitudinal motion.

The tilting threshold preferably is comprised between 0.5° and 5°, and still more preferably, it is equal to about 1°.

For example, the device can comprise an actuator 23 connected to the resting plate 20, to adjust the longitudinal position thereof (according to the arrow F in figure), so as to restore the correct horizontal attitude of the slide 15. Such correction takes place without interrupting the loading (or discharging) procedures.

The actuator which allows the motion of the plate 20 with respect to the slide 15 for example can be a hydraulic piston 23, having an adequate stroke. Such piston 23 has the fixing element semi-fixed and positionable along the slide itself as a function of the length of the tube bundle to be balanced, to allow a wider degree of balancing.

According to a possible embodiment of the extractor 1, the bearing slide 15 comprises a pair of beams 2 arranged side by side therebetween in the longitudinal direction of the machine. Preferably, the beams are made of steel and have a length suitable to the length of the load to be moved.

According to an embodiment of the extractor 1, the hooking and dragging means 3, 4, 5, 6, 10 comprises a movable head 5, slidably mounted on the bearing slide 15. A terminal of the load to be moved could be hooked to the movable head 5.

The hooking and dragging means 3, 4, 5, 6, 10 further comprises a motor 10 actuating a transmission system 3, 4, apt to transfer the motion of the motor 10 to the movable head 5 so as to allow the controlled sliding thereof along the bearing slide 15, in both directions.

For example, each beam 2, on each end, supports a toothed wheel 3, therebetween a steel chain 4 is mounted, the lower branch thereof passes inside the pair of beams and the upper branch passes on the upper outer face of the same pair of beams. The mobile head 5 is connected to the upper branch of the chain 4. One of the two toothed wheels 3 has its own axis keyed to the motor 10, for example a hydraulic motor, with reversible rotation direction, capable of generating the driving (or pushing) force required for motion.

Advantageously, the movable head 5 can be arranged so that it can be adjusted in height with respect to the plane of the bearing slide 15. In this case, the hooking and dragging means 3, 4, 5, 6, 10 further comprises an actuator for moving in height the movable head 5. Such actuator advantageously could be an additional hydraulic piston. Such mechanism for adjusting in height allows a correct vertical positioning of the machine, and in particular of the movable head 5, in front of the load to be handled.

At one of the ends of the machine, the one which is placed in front of the load to be taken and moved (generally designated with 30 in figure), means for locking the bearing slide 15 on an external structure therefrom the tube bundle is to be extracted can be provided.

For example, such means can comprise hooks for the sling (or rope or chain), which serves to lock the machine to the structure thereon one works, and a hydraulic piston 31 (with the necessary countershafts), for tensioning the sling itself.

At the opposite end of the slide 15, generally designated with 40 in figure, a power and propulsion group 11 can advantageously be provided.

In particular, the group 11 can comprise: a combustion (or electric or pneumatic) engine, the hydraulic oil pump, the diesel fuel tank, the hydraulic oil (or compressed air) tank, the oil distribution valves, the electric battery. The motor start preferably is electrically driven with a low voltage remote control.

Then, operationally, when a tube bundle has to be extracted, the machine could be hooked to a lifting system and placed with the end 30 at the bundle to be extracted.

The slide could be then locked onto the structure therefrom the load has to be taken. The load could be hooked to the movable head which in turn will have been adjusted in height for greater precision.

At this point, by actuating the motor 10, the movable head can be driven along the slide and the load with it. Load supporting and stabilization elements 6 can be advantageously provided along the slide 15.

During the procedure for towing the load on the slide, the longitudinal position of the resting plate 20 could be continuously adjusted thanks to the automatic balancing system 100, so as to maintain always an optimum balance.

Once loaded, the slide could be detached from the outer structure and the load moved according to needs, for example brought to the ground. Once the tube bundle is returned to the ground, performing the subsequent processing actions will be quick and safe.

The present invention has been sofar described with reference to preferred embodiments thereof, together with some embodiment variants. It is to be meant that each one of the variants and the technical solutions implemented in the preferred embodiments, herein described by way of example, could advantageously be combined differently therebetween, to form other embodiments, belonging to the same inventive core and all however within the protective scope of the herebelow reported claims.

1. An integrated balancing system of an aerial tube bundle extractor, said extractor comprising a bearing slide having means for the aerial suspension, and means for hooking and dragging said tube bundle on said slide, the system comprising:
a device for the longitudinal motion of said means for the aerial suspension;
one or more tilting sensors, arranged so as to be able to detect tilting variations of said slide with respect to a reference line;
a control unit, preferably a microprocessor, programmed to acquire continuously data measured by said tilting sensors, to process them to verify if they exceed a predefined tilting threshold, and in case such threshold is exceeded, to actuate instantaneously the device for the longitudinal motion.

2. The system according to claim 1, wherein said device for the longitudinal motion comprises an actuator, which can be actuated by said control unit, connected to said means for the aerial suspension.

3. The system according to claim 2, wherein said actuator for the longitudinal motion is a hydraulic piston.

4. The system according to claim 1, wherein said tilting threshold is comprised between 0.5° and 5°, preferably it is equal to 1°.

5. An aerial tube bundle extractor comprising a bearing slide having means for the aerial suspension, and means for hooking and dragging said tube bundle on said slide, and further comprising an automatic balancing system according to claim 1.

6. The aerial tube bundle extractor according to claim 5, wherein said means for the aerial suspension comprises a resting plate of said bearing slide, slidably mounted below said bearing slide.

7. The aerial tube bundle extractor according to claim 6, wherein said means for the aerial suspension comprises a supporting structure integral to said resting plate and having a suspension element.

8. The aerial tube bundle extractor according to claim 5, wherein said bearing slide a pair of side-by-side beams.

9. The aerial tube bundle extractor according to claim 5, wherein said hooking and dragging means comprises a movable head, slidingly mounted on said bearing slide.

10. The aerial tube bundle extractor according to claim 9, wherein said hooking and dragging means comprises a motor actuating a transmission system adapted to transfer the motion to said movable head so as to allow the controlled sliding thereof along said bearing slide in both directions.

11. The aerial tube bundle extractor according to claim 10, wherein said transmission system comprises at least a pair of toothed wheels and a drive chain.

12. The aerial tube bundle extractor according to claim 9, wherein said movable head is adapted to be adjusted in height with respect to a plane of said bearing slide and said hooking and dragging means comprises an actuator for moving said movable head in height.

13. The aerial tube bundle extractor according to claim 5, comprising means for locking one end of the bearing slide on an external structure therefrom the tube bundle is to be extracted.

14. The aerial tube bundle extractor according to claim 5, comprising a power and propulsion group.

15. The aerial tube bundle extractor according to claim 14, wherein said power and propulsion group comprises: a motor, a hydraulic propulsion system and an electrical power supply system.
